(19) United States
(12) Patent Application Publication
(10) Pub. No.: US 2012/0055993 A1
(43) Pub. Date: Mar. 8, 2012

(54) METHOD FOR CODING/INDIVIDUALIZING A CONTAINER USED TO RECEIVE NUTRIENT SOLUTIONS OR CULTURE MEDIA

(75) Inventor: Rolf Müller, Dossenheim (DE)

(73) Assignee: HEIPHA GMBH, Eppelheim (DE)

(21) Appl. No.: 13/145,320

(22) PCT Filed: Nov. 19, 2009
(86) PCT No.: PCT/DE09/01632

§ 371 Date: Aug. 30, 2011

(30) Foreign Application Priority Data
Jan. 20, 2009 (DE) 10 2009 005 542.8
Feb. 3, 2009 (DE) 10 2009 007 282.9

(51) Int. Cl. G06K 19/06; G06K 7/01

(52) U.S. Cl. 235/439; 235/494

(57) ABSTRACT

A method for coding/individualizing a container used to receive nutrient solutions or culture media, in particular for cultivating microorganisms, cell cultures, bacteria and the like, the container being assigned a code, characterized in that the code is designed to be machine-readable, issued by the manufacturer and assigned to the container and that on the user side the code is assigned to a process as a data record.

The invention relates to a method for coding/individualizing a container used to receive nutrient solutions or culture media (medium), in particular for cultivating microorganisms, cell cultures, bacteria and the like, the container being assigned a code.

Containers used to receive nutrient solutions or culture media, in particular for cultivating microorganisms, cell cultures, bacteria and the like are well known in the practice, in particular for use in the field of hygiene monitoring. Normally, they are dishes with a cover sold on the market under the brand name “Petri dishes.” Specifically, they are flat, round, usually transparent glass or plastic dishes with an overlapping cover (or vice versa), wherein said dishes are normally used for biological or chemical applications to cultivate microorganisms or to grow cell cultures. Reference to DE 44 06 726 A1 which illustrates said type of Petri dish is purely exemplary with respect to such a container. Vials, flasks, impression dishes and other containers can also be used for the preparation of culture media and as a result for the cultivation of microorganisms.

The demand for containers with culture media is growing constantly. Work is not only being performed in clean rooms where the particle contamination must be kept below defined values for bioresearch and medical research, but also for the semiconductor manufacture. The contamination control with respect to various substances must be monitored accordingly. Amongst other things, so-called particle measuring devices are used for this purpose.

So-called impression dishes are used to collect swabs and samples from various areas of monitored rooms. The collected samples are cultivated and evaluated on culture media, allowing the qualification and quantification of microorganism contamination of the respective room.

In the past, the sample collector labeled the respective impression dish or the culture medium and—depending on the use—the container with the swab manually, for instance on a label or by means of a suitable pen directly on the container. However, the manual labeling of said container is problematic insofar that incorrect assignments may occur due to mix-ups and/or difficult to read handwriting. Moreover, there is a risk of unintended and intended manipulation caused by the random or systematic allocation of a handwritten code or handwritten labeling.

Insofar, utmost caution is required when cultivated microorganisms or cell cultures, bacteria and the like are used to make inferences on a specific sample collection. Repeat sampling to confirm the results is often required. Furthermore, the handling of the containers used to cultivate microorganisms, cell cultures, bacteria and the like as well as the archiving is complicated and therefore expensive. Supplementary information needs to be assigned to the samples, is usually transferred to a log book, again using handwritten entries.

The object of the invention at hand is to provide a method for coding/individualizing a container used to receive nutrient solutions or culture media (medium), in particular for cultivating microorganisms, cell cultures, bacteria and the like, wherein the container is being assigned a code to help exclude common mix-ups associated with the handwritten assignment of a code. Furthermore, subsequent manipulations shall also be excluded.

According to the invention, the object mentioned above is solved with the characteristics of patent claim 1. Accordingly, the method according to the invention is characterized in that the code is designed to be machine-readable, issued by the manufacturer and assigned to the container and that on the user side the code is assigned to a process as a data record.

According to the invention, it was discovered that the code used for archiving is specified by the manufacturer and assigned to the container. The user assigns this code to a process as a data record, specifically to the sample collection, when utilizing the container and the medium, i.e. when using the container. As a result, the handwritten labeling of the container for the sample collection is no longer required.

In principle, it is beneficial if the code is generated and assigned to the container by the manufacturer after the filling process. Advantageously, the code is created as a two-dimensional data matrix code.

For the proper identification, it is beneficial if the code comprises information concerning the medium and the batch. For this purpose, the medium can be described with three to five characters and the batch with three to eight characters.

Moreover, the code may comprise information concerning the shelf life of the medium. The shelf life can be described for example with six to eight characters.

For further individualization, the code comprises a consecutive serial number. It can be described with three to ten characters. Overall, it is conceivable that the code assigned by the manufacturer comprises a total of fifteen to twenty-five characters, preferably nineteen characters.

As mentioned above, the code is provided on the container filled with culture medium to ensure that the mix-up of the container and as a result the culture medium is impossible. Preferably, the code can be printed directly onto the container by means of a laser. As well, it is possible that the code is printed on a label and the label is glued onto the container, preferably on the side of the container. The code can be created or printed by means of a laser printer, ink jet printer or thermal transfer printer.

At this point we would like to add that it is generally advantageous to assign the code to the container comprising the medium rather than to the cover, so that mix-ups in this respect can also be prevented effectively.

It is particularly preferable if a scanner for automatic recognition/reading of the respective code and as a result the container including the content is provided. The scanner is preferably designed as a hand-held device. The size of said scanner can be similar to the size of a mobile phone, an MP3 player, etc. As well, it is possible to design the scanner with a gun-like knob for better handling.

It is particularly preferable if the scanner comprises a removable disk to archive data and transfer data, if necessary. This can be a traditional data card. The use of any data carrier is possible.

Furthermore, it is advantageous if the scanner comprises its own data processing processor. Alternatively or additionally, the scanner is connected to a computer, preferably via a wireless interface, for example by means of wireless communication, Bluetooth or W-LAN. If long-distance data transmission is required, the data can be transmitted via an internal W-LAN network and the internet to an external computer, where it can be processed, possibly centrally.

In any case, it is advantageous if the scanned codes/data and data records are archived and managed via a processor on a database.

It is particularly advantageous if the user adds at least some information pertaining to the content to be cultivated and/or the sample collection to the code or the data records. The code-related data can be processed and/or supplemented before and/or after archiving it.

Moreover, it is advantageous if the data or the data records are supplemented with more information/data via a terminal and/or a reader. Analogously, the additional data can for example be entered by means of a keyboard or a reader, such as a scanner. Is it also conceivable that the scanner is equipped with a camera with a reasonable resolution, similar to a modern cell phone, allowing the assignment of image data to the respective data records, for example images of the sample collection location.

Generally, the data records can be supplemented with any data, for example with data relating to the sample collection location, data concerning the date and/or time of the sample collection, data concerning the sample collector, data concerning a task list number, data concerning a scanner ID, etc. We would like to add that the data records—after the sampling—contain an individualized code of the container with culture medium and a consecutive number on the one hand and additionally can be supplemented with sampling-related data on the other hand. This can concern any type of data, for instance written information but also image information.

In addition, we would like to add that the method according to the invention is based on special application software. The latter can for example also be used to generate a task list for the scanner and it can be used by the sample collector, wherein it is additionally advantageous if the task list can be edited at will.

A number of options are available to shape and further develop the method of the invention at hand in an advantageous manner. For this purpose, we would like to refer to the patent claims following patent claim 1 on the one hand and the explanation of preferred process steps of the invention based on the figures below on the other hand. Generally preferred embodiments and further developments of the method are also explained in connection with the explanation of preferred process steps of the invention based on the figures. In the figures

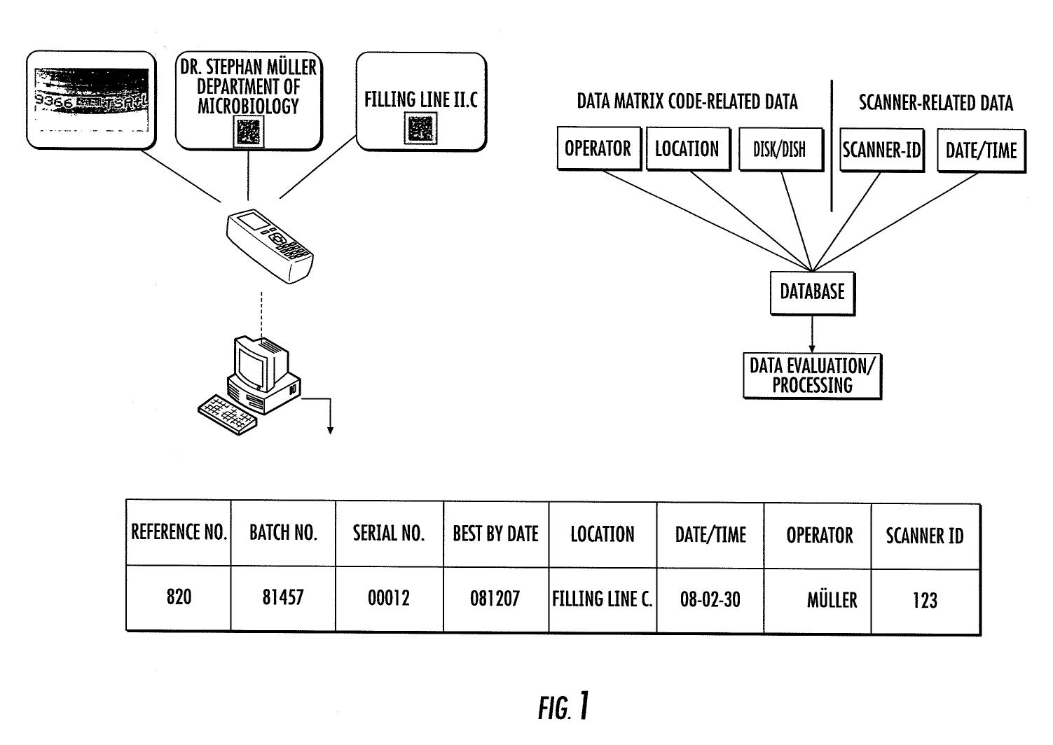

FIG. 1 shows the coding scheme in a schematic view on the one hand and the process sequence when using a scanner on the other hand,

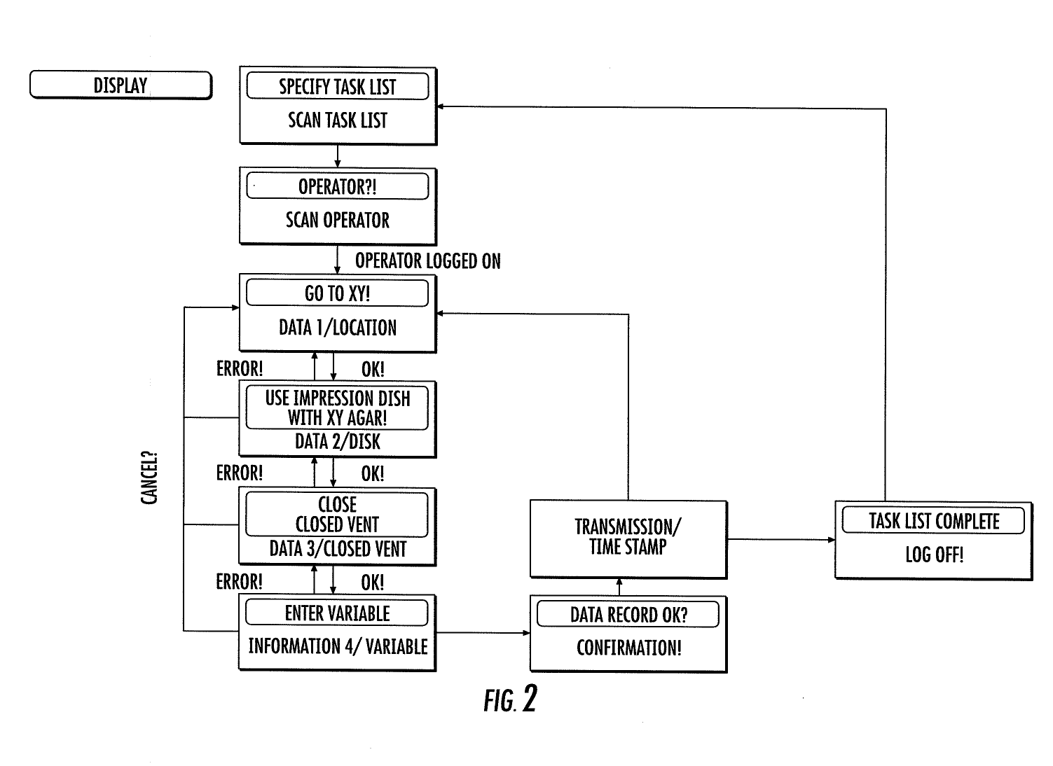

FIG. 2 shows a schematic illustration of the operating sequence of a hygiene monitoring according to the method according to the invention in a block diagram and

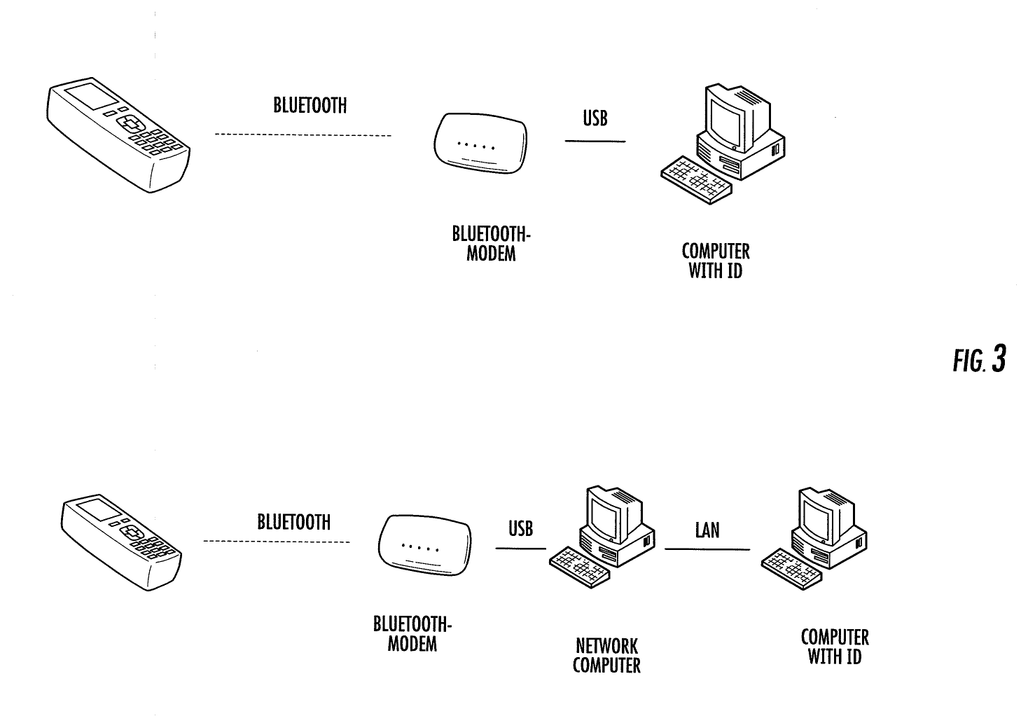

FIG. 3 shows schematic views of two scanner communication variants via an interface with the computer for use of the method according to the invention.

The method according to the invention is suitable for clean room conditions with the use of a scanner to record a data matrix code of containers comprising a culture medium, wherein so-called impression dishes can specifically be used.

The container comprising the culture medium is already being provided with a code from the manufacturer, containing the item number and batch number along with a best before date and a sequential number (serial number).

The user adds the sampling location, the date and time of the sampling, the user/operator name and the scanner identification to the data record provided by the manufacturer, wherein the scanner identification is added automatically, namely by means of the scanner. Insofar, we would like to refer to FIG. 1 which is self-explanatory thanks to the legend.

The method according to the invention allows the conduct of a so-called hygiene monitoring. We would like to add the following in this regard:

With reference to FIG. 2, the hygiene monitoring starts with the compilation of a monitoring schedule by means of the software. The monitoring schedule comprises all the steps and stations where hygiene monitoring is to be performed during the process. The task lists are archived in a folder on the network. The operator logs into the scanner by scanning his personal code. The scanner synchronizes the workplaces of the network folder by scanning a certain code (optional: automatic daily synchronization). Scanning a code opens a specific task list (e.g.: weekly hygiene monitoring of a specific production area). The task list contains information about whether and to what extent the corresponding operator has permission to carry out the task list. The individual steps of the task list are acknowledged (location/disk). The scanner adds the workplace number, date, time and its own ID to the respective generated data record. The collected data is displayed once more at the end of every work step and archived by pressing a confirmation button. The collected data of a task list is archived in a results folder on the network by scanning the corresponding code.

With reference to FIG. 3, the data collection and data transfer is carried out as follows:

The scanner comprises an internal storage used to archive task lists and collected data. Said data can be sent to a remote computer (for example a computer with Bluetooth receiver) via Bluetooth modem integrated in the scanner. Two variants are provided for this purpose. Variant 1: direct communication with the computer with a specific ID installed on it. Variant 2: communication between the scanner and a computer with network connection. Archiving of the data on a network folder which is accessible via computer with the relevant ID installed on it.

As already explained in the general part of the description, the method according to the invention is based on special software. Said software is capable of the following:

With Respect to the Task List:

The user can create and edit work steps for the hygiene monitoring in the task list. Specifications concerning the sampling location and the medium to be used can be made in every work step. Reference/control values for the work steps can be stored in the task list (e.g. work step 1: machine A, medium B), and are verified by scanning the corresponding codes (of the machine, dish, etc.). The user can archive task lists in a definable network folder. The accessibility and editability of task lists can be associated with user permissions. The task list can be structured in table format. The task list can be printed out. The work steps can be shown legibly on the display of the scanner. The task lists can be transmitted to the scanner via a network. They shall be provided in a scanner-processable format.

With Respect to the User Interface:

All scanned data can preferably be displayed in table format. The user can open the corresponding user interface by scanning the disk.

With Respect to the Sample Identification:

When an item number is cued, the item description can be displayed by means of a table stored on the computer. Said table shall be easy to update.

It is possible to change the device no., the cap no., the rotor no., the calibration, etc.

For impression dishes, the field “Measurement end” can remain blank. Other information such as volume/error code/interval measurement/number of intervals can be enabled or hidden.

With Respect to the Count:

The number of counts can be increased. For instance, the user can click on the “anaerobic” checkbox behind the commentary.

With Respect to the Technical Requirements (in Bullet Form):

Hand-held device to record the data matrix code. The data matrix code must be readable. Other codes (machine/personal ID) can be readable.

Suitable for use in clean rooms/isolators.

Inert to disinfectants, inert to H₂O₂.

Battery operation for 6-8 h possible.

Charged via inductor coil suitable for use in clean rooms.

Data transmission via Bluetooth or W-LAN.

Display to show the disk, location, user (e.g. 4×16 characters).

Holder assembly to lock in the Petri dish.

Control commands must be possible (e.g. to display the respective last data record, delete a data record).

Serial number.

With Respect to the General Software Requirements:

The user should be able to log in to the scanner by scanning a personal ID. The user should be able to download the task lists from a defined network folder by scanning a code. It should be possible to start a task list by scanning a code.

The data records collected while processing a task list can be archived in a database. The data record identifier is composed of the task list number, date and time.

The data records collected while processing a task list can be archived in a database. The data record identifier is composed of the task list number, date and time.

The software should break down the data matrix code into its components and assign them to the corresponding fields of a data record. Preferably, the software should automatically add the scanner ID, operator ID, task list number, date and time to every data record.

The scanner should issue a warning if a disk is read twice while a task list is being processed. The user should be able to navigate around the task list (next/last work step; delete this data record; skip entry; cancel; new task list).

Finally, we would like to note that the process steps, examples and characteristics mentioned above only serve the exemplary discussion of the claimed method without limiting the latter to the examples.

1.-28. (canceled)

29. A method for coding/individualizing a container used to receive nutrient solutions or culture media (medium), in particular for cultivating microorganisms, cell cultures, bacteria and the like, the container being assigned a code, wherein the code is designed to be machine-readable, issued by the manufacturer and assigned to the container and that on the user side the code is assigned to a process as a data record.

30. The method according to claim 29, wherein the code is generated by the manufacturer before, during or after the container is filled with the respective medium and assigned to the container.

31. The method according to claim 29, wherein the code is designed as a two-dimensional data matrix code.

32. The method according to claim 29, wherein the code comprises information concerning the medium and the batch.

33. The method according to claim 32, wherein the medium is described with three to five characters and the batch with three to eight characters.

34. The method according to claim 29, wherein the code comprises information concerning the shelf life of the medium.

35. The method according to claim 34, wherein the shelf life is described with five to eight characters.

36. The method according to claim 29, wherein the code comprises a sequential serial number.

37. The method according to claim 36, wherein the serial number is described with two to ten characters.

38. The method according to claim 29, wherein the code comprises 15 to 25 characters, preferably 19 or 20 characters.

39. The method according to claim 29, wherein the code is preferably printed onto the container by means of a laser, ink jet printer or thermal transfer printer.

40. The method according to claim 29, wherein the code is preferably printed onto a label by means of a laser printer or ink jet printer or thermal transfer printer and the label is glued onto the container.

41. The method according to claim 40, wherein the label is attached to the container on the side.

42. The method according to claim 29, wherein a scanner is used for the automatic recognition/reading of the respective code and as a result the container plus content.

43. The method according to claim 42, wherein the scanner comprises a removable disk to store data and for data transfer, if necessary.

44. The method according to claim 42, wherein the scanner comprises a processor for data processing.

45. The method according to claim 42, wherein the scanner corresponds with a computer via a cable or wireless interface, preferably by means of wireless communication, Bluetooth or W-LAN.

46. The method according to claim 45, wherein the data is transferred via the interne.

47. The method according to claim 29, wherein the scanned codes/data are archived/managed via a processor in a database.

48. The method according to claim 29, wherein the code can be supplemented by the user with at least some information relating the content to be cultivated and/or relating to the sample collection.

49. The method according to claim 29, wherein the code-related data is edited and/or supplemented before and/or after being archived.

50. The method according to claim 49, wherein more information/data can be assigned to the data via a terminal and/or a reader.

51. The method according to claim 49, wherein the data record can be supplemented with data relating to the sampling location.

52. The method according to claim 49, wherein the data record can be supplemented with data relating to the data and/or time of the sample collection.

53. The method according to claim 49, wherein the data record can be supplemented with data relating to the sample collector.

54. The method according to claim 49, wherein the data record can be supplemented with data relating to a task list number.

55. The method according to claim 49, wherein the data record can be supplemented with data relating to a scanner ID.

56. The method according to claim 29, wherein special user software is provided which is used to create and edit if necessary a task list for the scanner.
